(19) United States
(12) Patent Application Publication
(10) Pub. No.: US 2021/0214487 A1
(43) Pub. Date: Jul. 15, 2021

(54) METHOD FOR PREPARING COMPOSITE MATERIALS MADE OF POLYETHYLENE FIBERS HAVING AN ULTRA-HIGH MOLECULAR WEIGHT AND CROSS-LINKED POLYISOCYANATES

(71) Applicant: COVESTRO INTELLECTUAL PROPERTY GMBH & CO. KG, Leverkusen (DE)

(72) Inventors: Paul HEINZ, Leverkusen (DE); Dirk ACHTEN, Leverkusen (DE); Dirk DIJKSTRA, Leverkusen (DE); Heiko HOCKE, Leverkusen (DE)

(21) Appl. No.: 17/056,418

(22) PCT Filed: May 13, 2019
(86) PCT No.: PCT/EP2019/062218

§ 371 Date: Nov. 17, 2020

(30) Foreign Application Priority Data
May 17, 2018 (EP) 18172971.6

(51) Int. Cl. C08G 18/09; C08G 18/79; C08G 18/73; C08G 18/24; C08G 18/16; B33Y 70/10

(52) U.S. Cl. CPC C08G 18/092; C08G 18/792; B33Y 70/10; C08G 18/246; C08G 18/168; C08G 18/73

(57) ABSTRACT

The present invention relates to a method for preparing composite materials made of polyethylene fibers having an ultra-high molecular weight and cross-linked polyisocyanates, to the composite materials obtainable therefrom and to the use of such composite materials for producing components. The invention also relates to components consisting of or containing a composite material according to the invention.

The present invention relates to a process for producing composite materials from ultrahigh molecular weight polyethylene fibers and crosslinked polyisocyanates, to the composite materials obtainable therefrom and to the use of such composite materials for producing components and components consisting of or containing a composite material according to the invention.

Synthetic fibers based on polymers (polyamide, polyethylene etc.) are widely used in the chemical industry. Representatives of this class of particular interest are fibers based on polyethylene (PE), for example the so-called high-performance polyethylene fibers (HPPE). These typically consist of linear polyethylene having very high molecular weights (>500 kg/mol). They are therefore also known as ultrahigh molecular weight PE fibers (UHMWPE). WO 2015/059268 describes a production process for UHMWPE. EP 0 504 954 moreover describes the exceptional material properties of PE having molecular weights upwards of 500 kg/mol. Great emphasis is placed on properties such as abrasion resistance or chemicals resistance.

Fibers made of UHMWPE are usually obtained by the so-called gel spinning process. EP 2 287 371 and WO 2012/139934 describe the production of UHMWPE fibers by this process. The thus obtainable fibers feature a high crystallinity and exceptional material properties such as very high tensile strengths and moduli of elasticity coupled with extremely low weight. In fact the fibers have the highest ratio of strength to weight known to date (P.K. Mallick; Fiber-Reinforced Composites—Materials Manufacturing and Design; 2008; CRC Press—Taylor & Francis Group; Boca Raton). Such fibers are commercially available under trade names such as Dyneema or Spectra. These fibers are used primarily in ropes, cords and slings.

It is in principle desirable also to utilize the recited material properties of the UHMWPE fibers in composite materials, for example by embedding fibers in plastic resins. However, this has hitherto been possible only to a very limited extent (P. K. Mallick; Fiber-Reinforced Composites—Materials Manufacturing and Design; 2008; CRC Press—Taylor & Francis Group; Boca Raton). Although there is no shortage of attempts in this regard in the literature, efficient production of UHMWPE fiber composite materials has not been successful due to the extremely poor wettability of the fibers and thus comparatively poor adhesion of the plastic resins to the fibers.

A further problem that has hitherto been only inadequately solved is that good wetting of the fibers, for example by suitable nonpolar matrix materials at relatively high temperatures, has failed either because, especially at elevated temperatures, compatible matrix materials cause disruption of the crystalline structures by dissolution (for example nonpolar compounds based on styrene and/or butadienes), thus causing strength to suffer, or the necessary temperature of the curing process of the matrix exceeds the temperature stability of the fiber of about 150° C. and uncontrolled melting and recrystallization processes damage the pronounced long-range order of the fiber materials which is responsible for the strength of UHMWPE fibers.

It has surprisingly been found that plastics based on isocyanate formulations having a ratio of isocyanate groups to isocyanate-reactive groups of at least 200 are suitable as the embedding resin for UHMWPE fibers when these are contacted with UHMWPE fibers in liquid form and with an isocyanate concentration, here defined as the weight fraction of the isocyanate group in the reactive resin component, of >10% by weight and reacted in the presence of the UHMWPE fibers at reaction temperatures of <150° C., wherein >50% of the employed isocyanates react to afford symmetrical or asymmetrical polyisocyanurates by way of a trimerization.

In a first embodiment, the present invention relates to a process for producing a composite material from polymer fibers and crosslinked polyisocyanates, comprising the steps of:
a) providing a polyisocyanate composition A which contains polyisocyanates, and
b) catalytic crosslinking of the polyisocyanate composition A in the presence of at least one polymer fiber B and at least one crosslinking catalyst C to afford the composite material composed of polymer fibers and crosslinked polyisocyanates.

A composite material in the context of the present application is characterized in that the polymer fibers B are embedded in a polymer matrix which is formed by the catalytic crosslinking of the polyisocyanates present in the polyisocyanate composition. The composite material may have any desired shape achievable with the production process used.

In a preferred embodiment, the process according to the invention is characterized in that a pretreatment of the polymer fiber B to compatibilize it with the polyisocyanate composition A need not be carried out. In particular the composite material according to the invention may be produced according to the process described hereinabove without the polymer fiber B being subjected to a gas plasma treatment, irradiated with UV light of <400 nm in wavelength or subjected to oxidative treatment, in particular with peroxides, oxidizing acids or ozone before performance of process step b).

Cleaning of the polymer fiber with organic solvents, inorganic solvents or by mechanical treatment is not understood as compatibilization in the present application.

Polyisocyanate Composition A

The term “polyisocyanate” as used here is a collective term for compounds containing two or more isocyanate groups (this is understood by the person skilled in the art to mean free isocyanate groups of the general structure —N═C═O) in the molecule. The simplest and most important representatives of these polyisocyanates are the diisocyanates. These have the general structure O═C═N—R—N═C═O where R typically represents aliphatic, alicyclic and/or aromatic radicals.

Because of the polyfunctionality (at least two isocyanate groups), it is possible to use polyisocyanates to produce a multitude of polymers (e.g. polyurethanes, polyureas and polyisocyanurates) and low molecular weight compounds (for example those having uretdione, isocyanurate, allophanate, biuret, iminooxadiazinedione and/or oxadiazinetrione structure).

Where reference is made here to “polyisocyanates” in general terms, this means monomeric and/or oligomeric polyisocyanates alike. For the understanding of many aspects of the invention, however, it is important to distinguish between monomeric diisocyanates and oligomeric polyisocyanates. Where reference is made here to “oligomeric polyisocyanates”, this means polyisocyanates formed from at least two monomeric diisocyanate molecules, i.e. compounds that constitute or contain a reaction product formed from at least two monomeric diisocyanate molecules.

The production of oligomeric polyisocyanates from monomeric diisocyanates is also referred to in this application as modification of monomeric diisocyanates. This “modification” as used here means the reaction of monomeric diisocyanates to give oligomeric polyisocyanates having uretdione, isocyanurate, allophanate, biuret, iminooxadiazinedione and/or oxadiazinetrione structures.

For example, hexamethylene diisocyanate (HDI) is a “monomeric diisocyanate” since it contains two isocyanate groups and is not a reaction product of at least two polyisocyanate molecules:

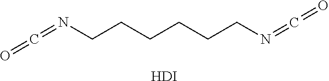

By contrast, reaction products of at least two HDI molecules which still have at least two isocyanate groups are “oligomeric polyisocyanates” in the context of the invention. Proceeding from monomeric HDI, representatives of such “oligomeric polyisocyanates” include for example the HDI isocyanurate and the HDI biuret each constructed from three monomeric HDI units:

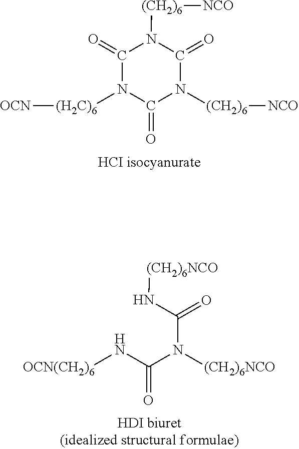

“Polyisocyanate composition A” in the context of the invention refers to the isocyanate component in the initial reaction mixture. In other words, this is the sum total of all compounds in the initial reaction mixture that have isocyanate groups. The polyisocyanate composition A is thus used as reactant in the process of the invention. Where reference is made here to “polyisocyanate composition A”, especially to “providing the polyisocyanate composition A”, this means that the polyisocyanate composition A exists and is used as reactant.

In principle, monomeric and oligomeric polyisocyanates are equally suitable for use in the polyisocyanate composition A according to the invention. Consequently, the polyisocyanate composition A may consist essentially of monomeric polyisocyanates or essentially of oligomeric polyisocyanates. It may alternatively comprise oligomeric and monomeric polyisocyanates in any desired mixing ratios.

In a preferred embodiment of the invention, the polyisocyanate composition A used as reactant in the crosslinking has a low level of monomers (i.e. a low level of monomeric diisocyanates) and already contains oligomeric polyisocyanates. The terms “low in monomers” and “low in monomeric diisocyanates” are here used synonymously in relation to the polyisocyanate composition A.

Since the use of monomeric polyisocyanates generates more heat than the use of corresponding masses of oligomeric polyisocyanates, the use of polyisocyanate compositions A having very high proportions of monomeric polyisocyanates has the risk that the temperature in parts of the composite material being formed will exceed the melting point of the employed PE fibers during the catalytic crosslinking. The proportion of monomeric polyisocyanates in the polyisocyanate composition is therefore preferably adjusted such that the temperature during the catalytic crosslinking does not exceed 150° C., preferably 140° C., particularly preferably 130° C. The proportion of monomeric polyisocyanates leading to exceedance of the abovementioned temperature limits depends on further parameters, in particular on the shape of the workpiece to be produced, i.e. the ratio of surface area to volume, on the proportion of the fibrous filler based on the total weight of the workpiece and also on the reaction rate and the possibility of dissipating reaction heat. The latter in turn depends substantially on the type and concentration of the employed catalyst. However, in individual cases the maximum possible proportion of monomeric polyisocyanates may be determined in simple fashion via temperature measurements using temperature sensors at various points on the component during the catalytic crosslinking. The critical limit can thus be experimentally determined with routine methods by a person skilled in the art.

Results of particular practical relevance are established when the polyisocyanate composition A has a proportion of monomeric diisocyanates in the polyisocyanate composition A of not more than 80% by weight, especially not more than 50% by weight or not more than 20% by weight, based in each case on the weight of the polyisocyanate composition A. It is preferable when the polyisocyanate composition A has a content of monomeric diisocyanates of not more than 5% by weight, especially not more than 2.0% by weight, more preferably not more than 1.0% by weight, based in each case on the weight of the polyisocyanate composition A. Particularly good results are established when the polymer composition A is essentially free of monomeric diisocyanates. “Essentially free” here means that the content of monomeric diisocyanates is not more than 0.5% by weight, based on the weight of the polyisocyanate composition A.

In a particularly preferred embodiment of the invention, the polyisocyanate composition A consists entirely or to an extent of at least 80%, 85%, 90%, 95%, 98%, 99% or 99.5% by weight of oligomeric polyisocyanates, based in each case on the weight of the monomeric and oligomeric polyisocyanates present in the polyisocyanate composition A. Preference is given here to a content of oligomeric polyisocyanates of at least 99% by weight. This content of oligomeric polyisocyanates relates to the polyisocyanate composition A as provided. In other words, the oligomeric polyisocyanates are not formed as an intermediate during the process according to the invention, but are already present in the polyisocyanate composition A used as reactant upon commencement of the reaction.

Polyisocyanate compositions which have a low level of monomers or are essentially free of monomeric isocyanates can be obtained by conducting, after the actual modification reaction, in each case, at least one further process step for removal of the unconverted excess monomeric diisocyanates. This removal of monomers can be effected in a particularly practical manner by processes known per se, preferably by thin-film distillation under high vacuum or by extraction with suitable solvents that are inert toward isocyanate groups, for example aliphatic or cycloaliphatic hydrocarbons such as pentane, hexane, heptane, cyclopentane or cyclohexane.

In a preferred embodiment of the invention, the polyisocyanate composition A according to the invention is obtained by modifying monomeric diisocyanates with subsequent removal of unconverted monomers.

In a particular embodiment of the invention, a polyisocyanate composition A having a low level of monomers, however, contains an outside monomeric diisocyanate. In this context, “outside monomeric diisocyanate” means that it differs from the monomeric diisocyanates which have been used for production of the oligomeric polyisocyanates present in the polyisocyanate composition A.

An addition of outside monomeric diisocyanate may be advantageous for achieving specific technical effects, for example a particular hardness. Results of particular practical relevance are established when the polyisocyanate composition A has a proportion of outside monomeric diisocyanate in the polyisocyanate composition A of not more than 50% by weight, preferably not more than 35% by weight, more preferably not more than 20% by weight and most preferably not more than 10% by weight, based in each case on the weight of the polyisocyanate composition A. It is preferable when the polyisocyanate composition A has a content of outside monomeric diisocyanate of not more than 5% by weight, preferably not more than 2.0% by weight, more preferably not more than 1.0% by weight, based in each case on the weight of the polyisocyanate composition A.

In a further particular embodiment of the process according to the invention, the polyisocyanate composition A contains monomeric monoisocyanates or monomeric isocyanates having an isocyanate functionality greater than two, i.e. having more than two isocyanate groups per molecule. The addition of monomeric monoisocyanates or monomeric isocyanates having an isocyanate functionality greater than two has been found to be advantageous in order to influence the network density of the material. Results of particular practical relevance are established when the polyisocyanate composition A has a proportion of monomeric monoisocyanates or monomeric isocyanates having an isocyanate functionality greater than two in the polyisocyanate composition A of not more than 20% by weight, especially not more than 15% by weight or not more than 10% by weight, based in each case on the weight of the polyisocyanate composition A. Preferably, the polyisocyanate composition A has a content of monomeric monoisocyanates or monomeric isocyanates having an isocyanate functionality greater than two of not more than 5% by weight, especially not more than 2.0% by weight, more preferably not more than 1.0% by weight, based in each case on the weight of the polyisocyanate composition A. It is preferable when no monomeric monoisocyanate or monomeric isocyanate having an isocyanate functionality greater than two is used in the crosslinking reaction according to the invention.

According to the invention, the oligomeric polyisocyanates may in particular have uretdione, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

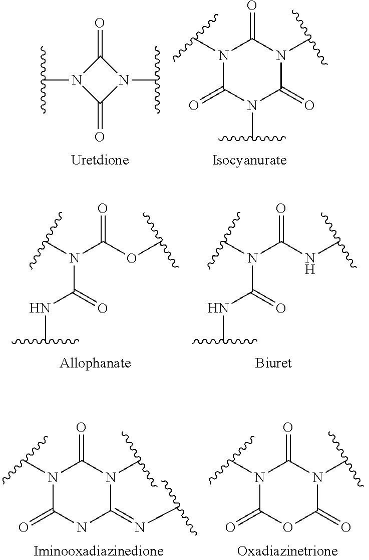

In a preferred embodiment of the invention, a polymer composition A wherein the isocyanurate structure component is at least 50 mol %, preferably at least 60 mol %, more preferably at least 70 mol %, even more preferably at least 80 mol %, even more preferably still at least 90 mol % and especially preferably at least 95 mol %, based on the sum total of the oligomeric structures from the group consisting of uretdione, isocyanurate, allophanate, biuret, iminooxadiazinedione and oxadiazinetrione structure present in the polyisocyanate composition A, is used.

In a further preferred embodiment of the invention, in the process according to the invention, a polyisocyanate composition A containing, as well as the isocyanurate structure, at least one further oligomeric polyisocyanate having uretdione, biuret, allophanate, iminooxadiazinedione and oxadiazinetrione structure and mixtures thereof is used.

The proportions of the uretdione, isocyanurate, allophanate, biuret, iminooxadiazinedione and/or oxadiazinetrione structures in the polyisocyanates A can be determined, for example, by NMR spectroscopy. It is possible here with preference to use ¹³C NMR spectroscopy, preferably in proton-decoupled form, since the oligomeric structures mentioned give characteristic signals.

Irrespective of the underlying oligomeric structure (uretdione, isocyanurate, allophanate, biuret, iminooxadiazinedione and/or oxadiazinetrione structure), the oligomeric polyisocyanate composition A for use in the process according to the invention and/or the oligomeric polyisocyanates present therein preferably have a (mean) NCO functionality of 2.0 to 5.0, preferably of 2.3 to 4.5.

Results of particular practical relevance are established when the polyisocyanate composition A to be used in accordance with the invention has a content of isocyanate groups of 8.0% to 28.0% by weight, preferably of 14.0% to 25.0% by weight, based in each case on the weight of the polyisocyanate composition A. Said isocyanate groups may be in blocked or free form. The abovementioned isocyanate content in that case is based on the theoretical proportion of isocyanate groups after removal of the blocking agent.

Production processes for the oligomeric polyisocyanates having a uretdione, isocyanurate, allophanate, biuret, iminooxadiazinedione and/or oxadiazinetrione structure for use in the polyisocyanate composition A according to the invention are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

In an additional or alternative embodiment of the invention, the polyisocyanate composition A according to the invention is defined in that it contains oligomeric polyisocyanates which have been obtained from monomeric diisocyanates, irrespective of the nature of the modification reaction used, with observation of an oligomerization level of 5% to 45%, preferably 10% to 40%, more preferably 15% to 30%. “Oligomerization level” is understood here to mean the percentage of isocyanate groups originally present in the starting mixture which are consumed during the production process to form uretdione, isocyanurate, allophanate, biuret, iminooxadiazinedione and/or oxadiazinetrione structures.

Suitable polyisocyanates for production of the polyisocyanate composition A for use in the process according to the invention and the monomeric and/or oligomeric polyisocyanates present therein are any desired polyisocyanates obtainable in various ways, for example by phosgenation in the liquid or gas phase or by a phosgene-free route, for example by thermal urethane cleavage. Particularly good results are established when the polyisocyanates are monomeric diisocyanates. Preferred monomeric diisocyanates are those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates. Further diisocyanates that are likewise suitable can additionally be found, for example, in Justus Liebigs Annalen der Chemie, volume 562 (1949) p. 75-136.

Suitable monomeric monoisocyanates which can optionally be used in the polyisocyanate composition A are, for example, n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate or any desired mixtures of such monoisocyanates. An example of a monomeric isocyanate having an isocyanate functionality greater than two which can optionally be added to the polyisocyanate composition A is 4-isocyanatomethyloctane 1,8-diisocyanate (triisocyanatononane; TIN).

In one embodiment of the invention, the polyisocyanate composition A contains not more than 30% by weight, especially not more than 20% by weight, not more than 15% by weight, not more than 10% by weight, not more than 5% by weight or not more than 1% by weight, based in each case on the weight of the polyisocyanate composition A, of aromatic polyisocyanates. As used here, “aromatic polyisocyanate” means a polyisocyanate having at least one aromatically bonded isocyanate group.

Aromatically bonded isocyanate groups are understood to mean isocyanate groups bonded to an aromatic hydrocarbyl radical.

In a preferred embodiment of the process of the invention, a polyisocyanate composition A having exclusively aliphatically and/or cycloaliphatically bonded isocyanate groups is used.

Aliphatically and cycloaliphatically bonded isocyanate groups are respectively understood to mean isocyanate groups bonded to an aliphatic and cycloaliphatic hydrocarbyl radical.

In another preferred embodiment of the process of the invention, a polyisocyanate composition A consisting of or comprising one or more oligomeric polyisocyanates is used, where the one or more oligomeric polyisocyanates has/have exclusively aliphatically and/or cycloaliphatically bonded isocyanate groups.

In a further embodiment of the invention, the polyisocyanate composition A consists to an extent of at least 50%, 70%, 85%, 90%, 95%, 98% or 99% by weight, based in each case on the weight of the polyisocyanate composition A, of polyisocyanates having exclusively aliphatically and/or cycloaliphatically bonded isocyanate groups. Practical experiments have shown that particularly good results can be achieved with polyisocyanate compositions A in which the oligomeric polyisocyanates present therein have exclusively aliphatically and/or cycloaliphatically bonded isocyanate groups.

In a particularly preferred embodiment of the process of the invention, a polyisocyanate composition A is used which consists of or comprises one or more oligomeric polyisocyanates, where the one or more oligomeric polyisocyanates is/are based on 1,4-diisocyanatobutane (BDI), 1,5-diisocyanatopentane (PDI), 1,6-diisocyanatohexane (HDI), isophorone diisocyanate (IPDI) or 4,4′-diisocyanatodicyclohexylmethane (H12MDI) or mixtures thereof. Polyisocyanate compositions A containing oligomeric HDI are preferred here.

In a particularly preferred embodiment of the present invention, the polyisocyanate composition A is further characterized in that it has a surface tension of not more than 45 mN/m, preferably not more than 40 mN/m and very particularly preferably not more than 35 mN/m before the catalytic crosslinking and has a surface energy of not more than 50 mN/m, preferably not more than 45 mN/m and very particularly preferably not more than 40 mN/m after the crosslinking.

In a preferred embodiment, the energy delta between the surface tension of the polyisocyanate composition A and the polymer obtainable therefrom according to the invention after crosslinking the polyisocyanate composition A is at least 2 mN/m and not more than 20 mN/m, preferably at least 4 mN/m and not more than 15 mN/m and particularly preferably at least 6 mN/m and not more than 12 mN/m.

In a particularly preferred embodiment, the surface tension (energy) of the polyisocyanate composition A is not more than 5 mN/m smaller and not more than 10 mN/m greater than the surface energy of the polymer fiber employed according to the invention and the surface energy of the crosslinked polymer of the polymer composition A obtainable according to the invention is at least 1 mN/m greater and not more than 20 mN/m greater having regard to the surface energy of the polymer fiber employed according to the invention.

The recited ratios of surface tension and surface energies of the polyisocyanate composition A according to the invention to the crosslinked polymers obtainable therefrom according to the invention were found to be particularly advantageous for achieving good wetting of the surface of the polymer fibers according to the invention.

It has surprisingly also been found that the relatively low surface tension (energy) of the polyisocyanate composition A employed according to the invention in conjunction with a relatively small change in surface energy upon conversion into the crosslinked polymer obtainable according to the invention makes it possible to achieve particularly good results in the initial wetting of polymer fibers having low surface energies in particular. It has further been found that the adhesion of the resulting polymers of the polyisocyanate composition A crosslinked according to the invention is good particularly when the surface energy of the polymer phase being formed changes only within the inventive limits.

The recited surface tensions and surface energies are in each case determined at 23° C. by methods commonly used by those skilled in the art. Surface tension is preferably measured by dynamic methods, for example the maximum bubble pressure method.

The surface energy of the polymeric surface of the crosslinked polyisocyanate composition A and of the polymer fiber are preferably determined by the contact angle method using test inks or the Wilhelmy method (single fiber method for fibers).

In a further preferred embodiment, the shrinkage of the employed polyisocyanate composition A during the crosslinking process during formation of the polymer fiber composite is >1.5 times less in the fiber direction than orthogonally to the fiber direction.

In a further preferred embodiment, the shrinkage of the employed polyisocyanate composition A during the crosslinking process during formation of the polymer fiber composite is <10%, preferably <6%, particularly preferably <5% and very particularly preferably <4%.

Polymer Fiber B

Any synthetic fiber is in principle suitable as polymer fiber B). The polymer fiber B) is preferably selected from the group consisting of cellulose fibers, regenerated protein fibers, polylactide fibers, chitin fibers, polyester fibers, polyamide fibers, polyimide fibers, polydiimide fibers, polyacrylic fibers, polyacrylonitrile fibers, polytetrafluoroethylene fibers, polychloride fibers, polyurethane fibers, polyethylene fibers and polypropylene fibers.

The polymer fiber is more preferably nonpolar. Particularly preferred nonpolar polymer fibers are polyethylene and polypropylene fibers. It is very particularly preferable when the polymer fiber B) is a polyethylene fiber. Especially preferred are the ultrahigh molecular weight polyethylene fibers (UHMWPE) defined hereinbelow.

The term “polymer fiber B” also refers to combinations of at least two of the abovementioned types of polymer fibers. However, it is preferable to use a polymer fiber B made only of fibers of one of the abovementioned types.

The term “ultrahigh molecular weight polyethylene fibers” relates to fibers made of polyethylene (PE). The PE has a number average molar mass of at least 360 kg/mol, more preferably at least 500 kg/mol, yet more preferably at least 1000 kg/mol and most preferably at least 1600 kg/mol. It is preferable not to exceed an upper limit of 11 400 kg/mol. The number average molar mass is particularly preferably in the range between 500 kg/mol and 8400 kg/mol, very particularly preferably between 1600 kg/mol and 8400 kg/mol.

The polydispersity (ratio of weight average molar mass to number average molar mass) of the PE fibers employable according to the invention while maintaining the abovementioned number average molecular weight is not more than 4.0; preferably not more than 3.5; more preferably not more than 3.0, and most preferably not more than 2.8. The lower limit of the polydispersity is at least 1.1.

The tensile strength of preferred fibers is more than 2500 N/mm². The parallel orientation of polyethylene chains is preferably at least 80%, more preferably at least 90%, particularly preferably at least 95%.

Particularly suitable fibers are commercially available from Koninklijke DSM N.V. under the “Dyneema” brand and from Honeywell International Inc. under the “Spectra” brand.

Fibers suitable according to the invention are obtainable by the processes described in EP 2 287 371, WO 2012/139934 and WO 2014/187948.

The fibers may be arranged unidirectionally, i.e. parallel to one another. However, the use of woven and knitted fabrics is also possible according to the invention. These may be arranged in one or more layers. The combination of unidirectionally oriented fibers with woven and/or knitted fabrics is also possible according to the invention.

In a preferred embodiment of the invention, the fiber content in the composite polyisocyanurate material is more than 3% by weight, preferably more than 10% by weight, more preferably more than 15% by weight, preferably more than 20% by weight, even more preferably more than 30% by weight, especially 50%, 60%, 70% by weight, based on the composite polyisocyanurate material.

In principle, polyethylene fibers exhibit poor bonding to the polymer matrix and require compatibilization via suitable pretreatments. This may be effected for example by silanization and/or corona treatment such as described by Bahramian et al., 2015, “Ultra-high-molecular-weight polyethylene fiber reinforced dental composites: Effect of fiber surface treatment on mechanical properties of the composites” Dental Materials, Vol. 31, 1022 to 1029. However it was surprisingly found in the context of the study upon which the present patent application is based, that no pretreatment of the PE fibers is required when using the isocyanurate plastics according to the invention as the matrix. Cleaning in a suitable solvent, preferably acetone, is sufficient to ensure sufficient adhesion of the PE fiber and the matrix material.

Crosslinking Catalyst C

Employable catalysts C for the crosslinking reaction include in principle all catalysts which at reaction temperatures of not more than 150° C., preferably not more than 130° C. and particularly preferably not more than 100° C. catalyze a crosslinking of isocyanate groups to afford at least one of the structures selected from the group consisting of isocyanurate, uretdione, biuret, urea, iminooxadiazinedione, oxadiazinetrione and allophanate groups.

Particularly preferred crosslinking catalysts C are compounds which accelerate the trimerization of isocyanate groups to isocyanurate or uretdione structures. Since depending on the catalyst used the formation of a structure is often accompanied by side reactions, for example trimerization to form iminoxadiazinediones (so-called asymmetric trimerizates), and when urethane groups are present in the starting polyisocyanate by allophanatization reactions, the term “trimerization” shall be understood as being synonymous also with these additionally occurring reactions in the context of the present invention.

In a particular embodiment catalysts according to the invention can catalyze a trimerization, preferably via the intermediate step of a uretdione formation.

Suitable catalysts C for the process of the invention are, for example, simple tertiary amines, for example triethylamine, tributylamine, N,N-dimethylaniline, N-ethylpiperidine or N,N′-dimethylpiperazine. Suitable catalysts also include the tertiary hydroxyalkylamines described in GB 2 221 465, for example triethanolamine, N-methyldiethanolamine, dimethylethanolamine, N-isopropyldiethanolamine and 1-(2-hydroxyethyl)pyrrolidine or the catalyst systems known from GB 2 222 161 that consist of mixtures of tertiary bicyclic amines, for example DBU, with simple aliphatic alcohols of low molecular weight.

Further trimerization catalysts C suitable for the process of the invention are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water onto 1,4-diazabicyclo[2.2.2]octane), the quaternary hydroxyalkylammonium hydroxides known from EP-A 37 65 or EP-A 10 589, for example N,N,N-trimethyl-N-(2-hydroxyethyl)ammonium hydroxide, the trialkylhydroxylalkylammonium carboxylates that are known from DE-A 2631733, EP-A 0 671 426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, for example N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C8-C10-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, for example choline bicarbonate, the quaternary ammonium salts which are known from EP 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

Suitable salts are the known sodium and potassium salts of linear or branched alkanecarboxylic acids having up to 14 carbon atoms, for example butyric acid, valeric acid, caproic acid, 2-ethylhexanoic acid, heptanoic acid, caprylic acid, pelargonic acid and higher homologs.

Likewise suitable as trimerization catalysts C for the process of the invention are a multitude of different metal compounds. Suitable examples are the octoates and naphthenates of manganese, iron, cobalt, nickel, copper, zinc, zirconium, cerium or lead or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are disclosed by DE-A 3 219 608, such as of propionic acid, butyric acid, valeric acid, caproic acid, heptanoic acid, caprylic acid, pelargonic acid, capric acid and undecylic acid, the alkali metal or alkaline earth metal salts of aliphatic, cycloaliphatic or aromatic mono- and polycarboxylic acids having 2 to 20 carbon atoms that are disclosed by EP-A 0 100 129, such as sodium benzoate or potassium benzoate, the alkali metal phenoxides disclosed by GB-A 1 391 066 and GB-A 1 386 399, such as sodium phenoxide or potassium phenoxide, the alkali metal and alkaline earth metal oxides, hydroxides, carbonates, alkoxides and phenoxides disclosed by GB 809 809, alkali metal salts of enolizable compounds and metal salts of weak aliphatic or cycloaliphatic carboxylic acids such as sodium methoxide, sodium acetate, potassium acetate, sodium acetoacetate, lead 2-ethylhexanoate, and lead naphthenate, the basic alkali metal compounds complexed with crown ethers or polyether alcohols that are disclosed by EP-A 0 056 158 and EP-A 0 056 159, such as complexed sodium carboxylates or potassium carboxylates and/or the pyrrolidinone potassium salt disclosed by EP-A 0 033 581, the mono- or polynuclear complex of titanium, zirconium and/or hafnium disclosed by application EP 13196508.9, such as zirconium tetra-n-butoxide, zirconium tetra-2-ethylhexanoate and zirconium tetra-2-ethylhexoxide, and tin compounds of the type described in European Polymer Journal, vol. 16, 147-148 (1979), such as dibutyltin dichloride, diphenyltin dichloride, triphenylstannanol, tributyltin acetate, tin octoate, dibutyl(dimethoxy)stannane, and tributyltin imidazolate.

Further crosslinking catalysts suitable for the process of the invention can be found, for example, in J. H. Saunders and K. C. Frisch, Polyurethanes Chemistry and Technology, p. 94 ff. (1962) and the literature cited therein.

The catalysts C can be used in the process according to the invention either individually or in the form of any desired mixtures with one another.

Particularly suitable for the process according to the invention are organic phosphine catalysts of general formula (I)

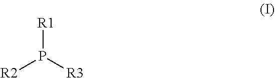

in which
R1, R2 and R3 are identical or different radicals and are each an alkyl or cycloalkyl group having up to 10 carbon atoms, preferably an alkyl group having 2 to 8 carbon atoms or a cycloalkyl group having 3 to 8 carbon atoms, an aralkyl group having 7 to 10 and preferably 7 carbon atoms, or an aryl group which has 6 to 10 and preferably 6 carbon atoms and is optionally substituted by alkyl radicals having up to 10 and preferably 1 to 6 carbon atoms, with the proviso that not more than one of the radicals is an aryl group and at least one of the radicals is an alkyl or cycloalkyl group, or in which
R1 and R2 are aliphatic in nature and, joined to one another, together with the phosphorus atom form a heterocyclic ring having 4 to 6 ring members, where R3 is an alkyl group having up to 4 carbon atoms,

or mixtures of such tertiary organic phosphine catalysts of general formula (I).

Suitable tertiary organic phosphine catalysts are, for example, tertiary phosphines having linear aliphatic substituents, such as trimethylphosphine, triethylphosphine, tri-n-propylphosphine, tripropylphosphine, dibutylethylphosphine, tri-n-butylphosphine, triisobutylphosphine, tri-tert-butylphosphine, pentyldimethylphosphine, pentyldiethylphosphine, pentyldipropylphosphine, pentyldibutylphosphine, pentyldihexylphosphine, dipentylmethylphosphine, dipentylethylphosphine, dipentylpropylphosphine, dipentylbutylphosphine, dipentylhexylphosphine, dipentyloctylphosphine, tripentylphosphine, hexyldimethylphosphine, hexyldiethylphosphine, hexyldipropylphosphine, hexyldibutylphosphine, dihexylmethylphosphine, dihexylethylphosphine, dihexylpropylphosphine, dihexylbutylphosphine, trihexylphosphine, trioctylphosphine, tribenzylphosphine, benzyldimethylphosphine, dimethylphenylphosphine or butylphosphacyclopentane.

Further tertiary organic phosphine catalysts that are suitable for the process according to the invention are, for example, also the tertiary phosphines known from EP 1 422 223 A1 that have at least one cycloaliphatic radical bonded directly to phosphorus, for example cyclopentyldimethylphosphine, cyclopentyldiethylphosphine, cyclopentyldi-n-propylphosphine, cyclopentyldiisopropylphosphine, cyclopentyldibutylphosphines with any isomeric butyl radicals, cyclopentyldihexylphosphines with any isomeric hexyl radicals, cyclopentyldioctylphosphine with any isomeric octyl radicals, dicyclopentylmethylphosphine, dicyclopentylethylphosphine, dicyclopentyl-n-propylphosphine, dicyclopentylisopropylphosphine, dicyclopentylbutylphosphine with any isomeric butyl radical, dicyclopentylhexylphosphine with any isomeric hexyl radical, dicyclopentyloctylphosphine with any isomeric octyl radical, tricyclopentylphosphine, cyclohexyldimethylphosphine, cyclohexyldiethylphosphine, cyclohexyldi-n-propylphosphine, cyclohexyldiisopropylphosphine, cyclohexyldibutylphosphines with any isomeric butyl radicals, cyclohexyldihexylphosphine with any isomeric hexyl radicals, cyclohexyldioctylphosphine with any isomeric octyl radicals, dicyclohexylmethylphosphine, dicyclohexylethylphosphine, dicyclohexyl-n-propylphosphine, dicyclohexylisopropylphosphine, dicyclohexylbutylphosphine with any isomeric butyl radical, dicyclohexylhexylphosphine with any isomeric hexyl radical, dicyclohexyloctylphosphine with any isomeric octyl radical, and tricyclohexylphosphine.

Further suitable tertiary organic phosphine catalysts for the process according to the invention are, for example, also the tertiary phosphines that are known from EP 1 982 979 A1 and have one or two tertiary alkyl radicals bonded directly to phosphorus, for example tert-butyldimethylphosphine, tert-butyldiethylphosphine, tert-butyldi-n-propylphosphine, tert-butyldiisopropylphosphine, tert-butyldibutylphosphines with any isomeric butyl radicals for the non-tertiary butyl radicals, tert-butyldihexylphosphines with any isomeric hexyl radicals, but where not more than one of the hexyl radicals has a tertiary carbon atom bonded directly to phosphorus, tert-butyldioctylphosphines with any isomeric octyl radicals, but where not more than one of the octyl radicals has a tertiary carbon atom bonded directly to phosphorus, di-tert-butylmethylphosphine, di-tert-butylethylphosphine, di-tert-butyl-n-propylphosphine, di-tert-butylisopropylphosphine, di-tert-butylbutylphosphines in which the non-tertiary butyl radical may be n-butyl, isobutyl, 2-butyl or cyclobutyl, di-tert-butylhexylphosphines with any isomeric hexyl radical having no tertiary carbon atom bonded directly to phosphorus, di-tert-butyloctylphosphines with any isomeric octyl radical having no tertiary carbon atom bonded directly to phosphorus, tert-amyldimethylphosphine, tert-amyldiethylphosphine, tert-amyldi-n-propylphosphine, tert-amyldiisopropylphosphine, tert-amyldibutylphosphines with any isomeric butyl radicals, but where not more than one of the butyl radicals is tert-butyl, tert-amyldihexylphosphines with any isomeric hexyl radicals, but where not more than one of the hexyl radicals has a tertiary carbon atom bonded directly to phosphorus, tert-amyldioctylphosphines with any isomeric octyl radicals, but where not more than one of the octyl radicals has a tertiary carbon atom bonded directly to phosphorus, di-tert-amylethylphosphine, di-tert-amylethylphosphine, di-tert-amyl-n-propylphosphine, di-tert-amylisopropylphosphine, di-tert-amylbutylphosphines in which the butyl radical may be n-butyl, isobutyl, 2-butyl or cyclobutyl, di-tert-amylhexylphosphines with any isomeric hexyl radical having no tertiary carbon atom bonded directly to phosphorus, di-tert-amyloctylphosphines with any isomeric octyl radical having no tertiary carbon atom bonded directly to phosphorus, adamantyldimethylphosphine, adamantyldiethylphosphine, adamantyldi-n-propylphosphine, adamantyldiisopropylphosphine, adamantyldibutylphosphines with any isomeric butyl radicals, but where not more than one of the butyl radicals has a tertiary carbon atom bonded directly to phosphorus, adamantyldihexylphosphines with any isomeric hexyl radicals, but where not more than one of the hexyl radicals has a tertiary carbon atom bonded directly to phosphorus, adamantyldioctylphosphines with any isomeric octyl radicals, but where not more than one of the octyl radicals has a tertiary carbon atom bonded directly to phosphorus, diadamantylmethylphosphine, diadamantylethylphosphine, diadamantyl-n-propylphosphine, diadamantylisopropylphosphine, diadamantylbutylphosphines in which the butyl radical may be n-butyl, isobutyl, 2-butyl or cyclobutyl, diadamantylhexylphosphines with any isomeric hexyl radical having no tertiary carbon atom bonded directly to phosphorus, and diadamantyloctylphosphines with any isomeric hexyl radical having no tertiary carbon atom bonded directly to phosphorus.

In the process according to the invention the tertiary organic phosphine catalyst is preferably selected from the group of the recited tertiary phosphines having linear aliphatic substituents.

Very particularly preferred tertiary organic phosphine catalysts are tri-n-butylphosphine and/or trioctylphosphine.

In the process according to the invention the tertiary organic phosphine catalyst is generally employed in a concentration based on the weight of the employed polyisocyanate composition A of 0.0005% to 10.0% by weight, preferably of 0.01% to 5.0% by weight and more preferably of 0.1% to 3.0% by weight and most preferably of 0.5% to 2.0% by weight.

The tertiary organic phosphine catalysts used in the process according to the invention generally have sufficient solubility in the polyisocyanate composition A in the amounts that are required for initiation of the oligomerization reaction. In this embodiment, the catalyst C is therefore preferably added to the polyisocyanate composition A in neat form.

Optionally, however, the tertiary organic phosphine catalysts can also be used dissolved in a suitable organic solvent to improve their incorporability. The dilution level of the catalyst solutions can be chosen freely within a very wide range. Catalyst solutions of this kind are typically catalytically active over and above a concentration of about 0.01% by weight.

In a preferred embodiment, the employed phosphorus-containing catalysts are sensitive to oxidation and after just a few hours to weeks are converted by oxidation into compounds which are no longer catalytically active and preferably colorless and preferably flame retardant. Such catalysts are for example phosphines having (cyclo)aliphatic radicals.

Likewise particularly suitable are alkali metal or alkaline earth metal salts of aliphatic, cycloaliphatic or aromatic mono- and polycarboxylic acids having 2 to 20 carbon atoms. The potassium salt of any of the abovementioned carboxylic acids is yet more preferred. Potassium acetate is particularly preferred.

However, all catalysts recited in WO 2016/170057, WO 2016/170059 or WO 2016/170061 are also suitable in principle provided they catalyze the crosslinking reaction in the abovementioned temperature ranges.

Particularly suitable as catalyst C are catalysts of formula (II) and their adducts. When a combination of a catalyst C1 and C2 is employed the abovementioned compounds are preferably employed as catalyst C2.

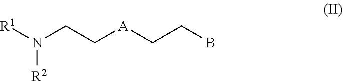

wherein R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl;
A is selected from the group consisting of O, S and NR³, wherein R³ is selected from the group consisting of hydrogen, methyl, ethyl, propyl, isopropyl, butyl and isobutyl; and
B is independently of A selected from the group consisting of OH, SH NHR⁴ and NH₂, wherein R⁴ is selected from the group consisting of methyl, ethyl and propyl.

In a preferred embodiment, A is NR³, wherein R³ is selected from the group consisting of hydrogen, methyl, ethyl, propyl, isopropyl, butyl and isobutyl. R³ is preferably methyl or ethyl. R³ is particularly preferably methyl.
In a first variant of this embodiment, B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R4 is selected from the group consisting of methyl, ethyl and propyl. It is preferable when R4 is methyl or ethyl. R4 is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

In a further preferred embodiment, A is oxygen.
In a first variant of this embodiment, B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R⁴ is selected from the group consisting of methyl, ethyl and propyl. It is preferable when R4 is methyl or ethyl. R4 is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

In yet a further preferred embodiment, A is sulfur.
In a first variant of this embodiment, B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R⁴ is selected from the group consisting of methyl, ethyl and propyl. It is preferable when R4 is methyl or ethyl. R4 is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

Also suitable are adducts of a compound of formula (II) and a compound having at least one isocyanate group.

The umbrella term “adduct” is understood to mean urethane, thiourethane and urea adducts of a compound of formula (II) with a compound having at least one isocyanate group. A urethane adduct is particularly preferred. The adducts of the invention are formed when an isocyanate reacts with the functional group B of the compound defined in formula (II). When B is a hydroxyl group a urethane adduct is formed. When B is a thiol group a thiourethane adduct is formed. And when B is NH₂ or NHR⁴ a urea adduct is formed.

Suitable catalyst solvents are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

If catalyst solvents are used in the process according to the invention, preference is given to using catalyst solvents which bear groups reactive toward isocyanates and can be incorporated into the polyisocyanurate resin. Examples of such solvents are mono- or polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethylallyl alcohol or oleyl alcohol; araliphatic alcohols, for example benzyl alcohol; N-monosubstituted amides, for example N-methylformamide, N-methylacetamide, cyanoacetamide or 2-pyrrolidinone, or any desired mixtures of such solvents.

In a particular embodiment, at least one crosslinking catalyst Cl and at least one crosslinking catalyst C2 are used.

The first catalyst C1 catalyzes the crosslinking of isocyanate groups to afford at least one of the structures selected from the group consisting of isocyanurate, uretdione, biuret, urea, iminooxadiazinedione, oxadiazinetrione and allophanate groups at reaction temperatures of below 100° C., preferably below 80° C., more preferably below 60° C. and yet more preferably below 50° C.

The second catalyst C2 catalyzes at least one of the abovementioned crosslinking reactions at reaction temperatures of at least 50° C., more preferably at least 60° C., yet more preferably at least 80° C. and most preferably at least 100° C. It is preferable when this catalyst C2 has only a low activity at temperatures below 100° C., preferably below 80° C., more preferably below 60° C. and yet more preferably below 50° C.

The catalyst has the desired activity at the recited temperature when it catalyzes a crosslinking of at least 15 mol % of the isocyanate groups present in the polyisocyanate composition A in not more than one hour, preferably not more than 3 hours and more preferably not more than 24 hours.

The term “low activity” refers to a crosslinking of not more than 10 mol % of the isocyanate groups present in the polyisocyanate composition A in a period of at least one hour, more preferably at least 3 hours and yet more preferably at least 24 hours.

Said first crosslinking catalyst C1 is preferably an organic phosphine catalyst of formula (I) as described hereinabove. The second catalyst C2 may be any desired catalyst. It is preferable to use one of the catalysts recited in WO 2016/170057, WO 2016/170059 or WO/2016/170061. It is more preferable when the second catalyst C2 is an alkali metal or alkaline earth metal salt of aliphatic, cycloaliphatic or aromatic mono- and polycarboxylic acids having 2 to 20 carbon atoms. It is yet more preferable when the second catalyst C2 is the potassium salt of any of the abovementioned carboxylic acids. The second catalyst is particularly preferably potassium acetate.

Catalytic Crosslinking

The term “catalytic crosslinking of the isocyanate composition A” relates to a process in which the isocyanate groups present in the polyisocyanate composition A react with one another, thus crosslinking the monomeric and/or oligomeric isocyanates present in the polyisocyanate composition

A with one another. Since this reaction is promoted by the crosslinking catalyst C it is also referred to as “catalytic crosslinking”. The crosslinking is preferably effected by forming at least one structure selected from the group consisting of isocyanurate, uretdione, biuret, urea, iminooxadiazinedione, oxadiazinetrione and allophanate groups. The crosslinking is in particular effected by forming isocyanurate groups and at least one more of the abovementioned structures.

In a preferred embodiment of the present invention the catalytic crosslinking is effected by forming isocyanurate groups to an extent of at least 30 mol %, more preferably at least 40 mol %, yet more preferably at least 50 mol %, yet more preferably at least 60 mol %, particularly preferably at least 70 mol % and very particularly preferably at least 80 mol %. The abovementioned values are determined by relating the number of isocyanurate groups in the cured material to the total number of isocyanurate, uretdione, biuret, urea, iminooxadiazinedione, oxadiazinetrione and allophanate groups.

It is particularly preferred when the molar ratio of isocyanate groups to isocyanate-reactive groups at commencement of process step b) expressed as the isocyanate index is at least 100, preferably at least 150 and yet more preferably at least 200. In the present context “isocyanate-reactive groups” is to be understood as meaning amino, thiol and hydroxyl groups, particularly preferably hydroxyl groups. It is immaterial how these abovementioned groups are introduced into the mixture present at commencement of process step b). This may be effected via impurities in the fiber B, via additions, for example catalyst solvents, to the crosslinking catalyst C or via direct addition. In any case it is essential that the abovementioned ratios are observed at commencement of process step b).

As shown in example 2 the presence of polyols in high concentrations/the formation of a large number of urethane groups has the result that the polymer fibers are not stably embedded into the matrix. It is therefore advantageous to limit the concentration of isocyanate-reactive groups in the reaction mixture.

According to the invention during process step b) the temperature ranges defined hereinbelow are observed over all parts of the composite material being formed. This temperature is also referred to as “reaction temperature”. Said temperature is to be distinguished from the temperature outside the composite material being formed, the “ambient temperature”.

The catalytic crosslinking is preferably performed at a reaction temperature of −20° C. to 150° C. Curing is performed particularly preferably in the temperature range from 0° C. to 130° C. and very particularly preferably from 20° C. to 120° C.

When particularly high glass transition temperatures are desired the catalytic crosslinking is preferably carried out at reaction temperatures between 100° C. and 140° C.

Since the catalytic crosslinking of isocyanate groups is an exothermic process the reaction temperature during the catalytic crosslinking depends not only on the ambient temperature. Said crosslinking is also influenced inter alia by the following parameters: Isocyanate proportion per weight unit of the composite material being formed, size and shape of the workpiece (i.e. ratio of heat evolution and heat removal via the surface), active cooling of the workpiece (or, where necessary, active heating) and the choice of catalyst (faster reactions result in stronger heating at identical heat removal rates).

Those skilled in the art know that they can utilize these parameters to control the reaction temperature prevailing during the catalytic crosslinking in the composite material. Thus for example a high weight fraction of isocyanate groups based on the total weight of the resulting composite material can be compensated by reducing the reaction rate by selecting a suitable catalyst in an appropriate concentration.

The temperature profile of the reaction may be monitored with temperature sensors so that it is possible in simple preliminary experiments to adjust the abovementioned parameters such that the desired temperature range is observed.

In a particular embodiment the temperature profile and the choice of catalyst for catalytic crosslinking of the matrix to afford at least 50 mol % of isocyanurate structures is optimized using a process simulation for each component. In this case, different catalyst concentrations/catalyst compositions and different temperature profiles are run for the desired component/semifinished product such as for example a pultrusion profile, a prepreg, an infusion mold, an SMC mold at different ambient temperatures/mold temperatures, wherein the matrix temperature is optionally measured over the course of the reaction via thermocouples or temperature sensors. An ideal processing strategy in terms of the temperature and the catalyst is developed from this parameter set.

The catalytic trimerization in the above-defined temperature ranges is preferably carried out using the above-described phosphines as at least one catalyst component. However, any other catalyst which effects crosslinking of isocyanate groups in these temperature ranges is also suitable.

The catalytic crosslinking of the isocyanate groups in the polyisocyanate composition A preferably has the result that at the end of the reaction at least 70%, preferably at least 80%, more preferably at least 90% and very particularly preferably at least 95% of the free isocyanate groups originally present in the polyisocyanate composition A have reacted. In other words the matrix of the composite material obtained by the process according to the invention preferably only contains not more than 30%, not more than 20%, particularly preferably not more than 10%, very particularly preferably not more than 5%, of the isocyanate groups originally present in the polyisocyanate composition A.

The course of the crosslinking reaction may initially be determined by titrimetric determination of the NCO content, but gelation and solidification of the reaction mixture set in rapidly as the reaction progresses, thus making wet chemistry analytical methods impossible. The further conversion of isocyanate groups can then be monitored only by spectroscopic methods, for example by IR spectroscopy using the intensity of the isocyanate band at about 2270 cm−1, or the increase in the matrix Tg may be monitored by DSC/DMA.

In a particularly preferred embodiment of the present invention, the catalytic crosslinking in process step b) is performed in two stages.

The lower limit of the temperature of the polyisocyanate composition A during process step b1) is at least −20° C., more preferably 0° C., yet more preferably 20° C. and most preferably 30° C. For process step b1) the temperature range is in particular preferably between at least 20° C. and not more than 120° C.

Process step b1) is preferably performed for at least 30 minutes.

The temperature of the polyisocyanate composition A is subsequently increased by at least 20° C. compared to process step b1) in a process step b2). The temperature of the polyisocyanate composition A in this case reaches a temperature of at least 50° C. but preferably does not exceed a temperature of 150° C. The crosslinking is continued at this temperature. Since higher crosslinking temperatures result in higher glass transition temperatures of the cured polyisocyanate composition A this makes it possible to obtain composite materials whose matrix has an elevated glass transition temperature.

Process step b2) is preferably performed for at least 5 minutes.

In this embodiment it is preferable to employ a combination of at least one crosslinking catalyst C1 and at least one crosslinking catalyst C2 as defined hereinabove.

A “catalytic crosslinking of the polyisocyanate composition A in the presence of at least one polymer fiber B” does not preclude the presence of further organic or inorganic fillers in addition to the polymer fiber B to be employed according to the invention. Especially in accordance with the invention are mixtures of polymer fibers B as defined in this application with other fibers.

However it is preferable when the volume fraction of the polymer fiber B based on the sum of all organic and inorganic fibrous and non-fibrous fillers is at least 20% by volume, more preferably at least 40% by volume, more preferably at least 50% by volume, yet more preferably at least 70% by volume and very particularly preferably at least 90% by volume.

In a particularly preferred embodiment of the present invention the above-defined volume fraction of the polymer fiber B is at least 95% by volume.

The present invention further relates to a composite material, characterized in that the composite material has a density of not more than 1.2 kg/l, preferably not more than 1.15, particularly preferably not more than 1.1, very particularly preferably not more than 1.05, determined according to DIN EN ISO 1183-1. The elastic modulus is at least 3 GPa, preferably at least 5 GPa, more preferably at least 10 GPa and very particularly preferably at least 15 GPa. The elastic modulus is preferably determined in the three-point bending test according to DIN EN ISO 14125:2011-05. Said composite material is further characterized in that it contains polymer fibers, preferably polyethylene fibers and particularly preferably ultrahigh molecular weight polyethylene fibers B that have not been compatibilized. The matrix of the composite material is preferably constructed from a catalytically crosslinked polyisocyanate composition A having an isocyanate index of at least 100, more preferably at least 150 and particularly preferably at least 200.

In the above-defined material the proportion of polyisocyanurate groups in the polymer matrix based on the total number of isocyanurate, uretdione, biuret, urea, iminooxadiazinedione, oxadiazinetrione and allophanate groups is at least 20 mol %, preferably at least 25 mol %, particularly preferably at least 30 mol % and very particularly preferably at least 35 mol %.

Products and Uses

In a further embodiment, the present invention relates to a composite material obtainable by the process according to the invention.

In a further embodiment, the present invention relates to the use of a composite material obtainable by the process according to the invention for producing a semifinished product/component. Components produced by the process according to the invention are preferably profiles, pipes, sheets or any desired other shaped articles. These may find use in various sectors such as automaking and shipbuilding, aerospace, house and plant building, personal protection, electronics, furnituremaking, oil extraction, medical technology or sports articles. Special mention should be made here of constructional, ballistic and/or crash-relevant components in airplanes, trains, automobiles, boats etc.

Preferred embodiments are any desired three-dimensional shaped articles from the “sheet molding compound” (SMC) process, for example housings, doors, roof modules, bumpers, shaped articles from the pultrusion process such as profiles, pipes and bars and any desired shaped articles or reinforcing elements formed from the use of prepregs, for example pipes, wings and any desired shaped articles formed from infusion processes, for example wind power blades, constructional elements in bridges and buildings and any desired elements having rotational symmetry such as are formed by filament winding, for example masts, pressure vessels, pipes and any desired shaped articles such as are formed by reaction injection molding.

In yet another embodiment, the present invention relates to any of the abovementioned components which contains or consists of a composite material obtainable by the process according to the invention.

In a further embodiment, the present invention relates to the use of the composite materials according to the invention for producing shaped articles and to shaped articles consisting of or containing the composite materials according to the invention.

A “shaped article” as used here is in particular a body having, in its direction of smallest extent, a thickness of at least 0.5 mm, preferably at least 1 mm, particularly preferably at least 2 mm. A “shaped article” as used here is in particular not a film or membrane.

The working examples which follow serve merely to illustrate the invention. They are not intended to limit the scope of protection of the claims in any way.

### EXAMPLES

General Information:

Unless otherwise stated all reported percentage values are in percent by weight (% by weight).

The ambient temperature of 23° C. at the time of performing the experiments is referred to as RT (room temperature).

Methods of Measurement:

The methods detailed hereinafter for determination of the appropriate parameters were used for performance and evaluation of the examples and are also the methods for determination of the parameters of relevance in accordance with the invention in general.

Determination of Phase Transitions by DSC

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The reported values are in each case based on evaluation of the 1st heating curve since in the investigated reactive systems, changes in the sample are possible in the measuring process at high temperatures as a result of the thermal stress in the DSC. The melting temperatures Tₘ were obtained from the temperatures at the maxima of the heat flow curves. The glass transition temperature T_{g} was obtained from the temperature at half the height of a glass transition step.

Determination of Infrared Spectra

The infrared spectra were measured on a Bruker FT-IR spectrometer equipped with an ATR unit.

Scanning Electron Microscopy

Scanning electron micrographs were captured on an FEI ESEM Quanta 400 scanning electron microscope (with tungsten cathode). The accelerating voltage was 10.0 kV. To enhance image contrast detection was accomplished using secondary electron/backscatter detection. The detector voltage was +100 V. A sample distance of 10 mm and a sample angle of 25° was employed.

Starting Compounds

Polyisocyanate A1: HDI trimer (NCO functionality >3) with an NCO content of 23.0% by weight from Covestro AG. The viscosity is about 1200 mPa·s at 23° C. (DIN EN ISO 3219/A.3).

Catalyst K1: Trioctylphosphine was obtained from Sigma-Aldrich in a purity of 97% by weight.

Catalyst K2: Dibutyltin dilaurate was obtained from Sigma-Aldrich in a purity of 95% by weight.

Polyethylene glycol (PEG) 400 was obtained from ACROS in a purity of >99% by weight.

Potassium acetate was obtained from ACROS in a purity of >99% by weight.

Glycerol was obtained from ACROS in a purity of >99% by weight.

All raw materials except for the catalyst were degassed under reduced pressure prior to use; the polyethylene glycol and the glycerol were additionally dried.

The PE fiber was a Dyneema gel-spun UHMWPE fiber from DSM.

The PE woven fabric was a woven material)(0°/90° made of Dyneema gel-spun UHMWPE fibers from DSM.

Thermal Properties of the Employed PE Fiber:

The thermal properties of the PE fiber were determined by DSC. The first heating curve yielded a melting temperature Tₘ of 151.5° C. with a heat of melting ΔHₘ of 269.4 J/g and the second heating curve yielded a melting temperature Tₘ of 137.7° C. with a heat of melting ΔHₘ of 147.1 J/g. This behavior is attributable to the high crystallinity of the gel-spun fiber and allows higher temperatures during crosslinking of the polymer resin than PE fibers produced by other means.

Production of Catalyst K3:

Potassium acetate (5.0 g) was stirred in the PEG 400 (95.0 g) at RT until all of it had dissolved. This afforded a 5% by weight solution of potassium acetate in PEG 400 which was used as catalyst without further treatment.

Production of Catalyst K4:

Potassium acetate (10.0 g) was stirred in the PEG 400 (90.0 g) at RT until all of it had dissolved. This afforded a 10% by weight solution of potassium acetate in PEG 400 which was used as catalyst without further treatment.

Production of the Reaction Mixture

Unless otherwise stated the reaction mixture was produced by mixing polyisocyanate A1 with a corresponding amount of catalyst (K1-4) and optionally a corresponding amount of glycerol at 23° C. in a Speedmixer DAC 150.1 FVZ from Hauschild at 2750 min-1. This was then either poured into a suitable mold for crosslinking without further treatment or added to the corresponding PE fibers or PE fabrics for further processing.

Cleaning of the Fibers

In order to free the PE fibers and PE fabrics from any compatibilizers and residues thereof the fibers are cleaned before use by placing in acetone for 30 minutes and subsequent rinsing and drying at RT.

Production of the Polyisocyanurate Composites

The polyisocyanurate composites are obtained by mixing the PE fibers with the corresponding reaction mixture or pouring the reaction mixture over the PE fabric and subsequent curing of the reaction mixture.

Production of the Polyisocyanurate Composites by Vacuum Infusion

Production of polyisocyanurate composites by vacuum infusion was carried out exclusively with PE fabric. A setup known from the standard literature was used (for example Hammami, A. and Gebart, B. R. (2000), Analysis of the vacuum infusion molding process. Polym Compos, 21: 28-40).

### Example 1 (Inventive)

As described above a mixture of polyisocyanate A1 (84.0 g) and catalyst K4 (1.68 g) was mixed in the Speedmixer at 2750 rpm for 6 min. The reaction mixture was subsequently added to the PE fiber (4 g) initially charged in an aluminum cup and stirred. The thus obtained mixture was pre-cured at 100° C. for 2 hours and subsequently cured at 140° C. for 10 minutes in a recirculating air oven. The thus obtained material was solid, clear and bubble-free. A fracture surface was produced on the test specimen by fracturing and subsequently examined for adhesion of the resin to the fiber in the scanning electron microscope. It was found that the fiber-resin adhesion was exceptionally good since the fibers broke off upon fracturing instead of being pulled from the resin. Furthermore, no gas envelopes were discernible around the fibers.

### Example 2 (Comparative)

As described above a mixture of polyisocyanate A1 (83.35 g), glycerol (14.02 g) and catalyst K2 (0.013 g) was mixed in the Speedmixer at 2750 rpm for 6 min. The reaction mixture was subsequently added to the PE fiber (4 g) initially charged in an aluminum cup and stirred. The thus obtained mixture was pre-cured in a recirculating air oven at 100° C. for 30 min. During pre-curing the fibers were precipitated/deposited at the surface of the resin due to lack of compatibility with the resulting polyurethane matrix and the experiment was accordingly abandoned. A determination of fiber-resin adhesion by scanning electron microscopy could not be performed.

### Example 3 (Comparative)

As described above a mixture of polyisocyanate A1 (84.0 g) and catalyst K4 (1.68 g) was mixed in the Speedmixer at 2750 rpm for 6 min. The reaction mixture was subsequently added to the PE fiber (4 g) initially charged in an aluminum cup and stirred. The thus obtained mixture was cured in a recirculating air oven at 140° C. over 10 min. As a consequence of the exothermicity of the crosslinking reaction the temperature in the composite material exceeded the melting temperature of the PE fibers. While the thus obtained material was solid it exhibited brown discolorations and marked bubbling. A determination of fiber-resin adhesion by scanning electron microscopy could not be performed since the fiber had melted during the course of curing due to the reaction enthalpy of the matrix.

### Example 4 (Inventive)

As described above a mixture of polyisocyanate A1 (100.0 g), catalyst K1 (0.5 g) and catalyst K3 (3.14 g) was mixed in the Speedmixer at 2750 rpm for 6 min. The reaction mixture was subsequently poured over a PE fabric (5×5 cm²). The thus obtained sample was cured over 5 days at RT. The thus obtained material was solid, clear and bubble-free. The structure of the PE fabric was also clearly discernible. A fracture surface was produced on a test specimen obtained by the same procedure by fracturing and subsequently examined for adhesion of the resin to the fabric in the scanning electron microscope. The result shows good compatibility and adhesion between the fabric and the resin.

### Example 5 (Inventive)

As described above a mixture of polyisocyanate A1 (98.0 g) and catalyst K1 (2.0 g) was mixed in the Speedmixer at 2750 rpm for 6 min. The reaction mixture was then applied to PE fabric in a vacuum infusion setup. The laminate was kept under vacuum for 5 days at RT. The thus obtained material was solid and bubble-free. The IR spectrum showed a residual isocyanate content of less than 50% (band at 2270 cm−1).

### Example 6 (Inventive)

As described above a mixture of polyisocyanate A1 (98.0 g) and catalyst K1 (2.0 g) was mixed in the Speedmixer at 2750 rpm for 6 min. The reaction mixture was then applied to PE fabric in a vacuum infusion setup. The laminate was kept under vacuum for 5 days at RT. The specimen was subsequently heat-treated for a further 2 hours at 120° C. in a recirculating air oven. The thus obtained material was solid and bubble-free. The IR spectrum showed a residual isocyanate content of less than 50% (band at 2270 cm−1).

### Example 7 (Inventive)

As described above a mixture of polyisocyanate A1 (98.0 g), catalyst K1 (1.0 g) and catalyst K3 (6.28 g) was mixed in the Speedmixer at 2750 rpm for 6 min. The reaction mixture was then applied to PE fabric in a vacuum infusion setup. The laminate was kept under vacuum for 5 days at RT. The thus obtained material was solid and bubble-free. The IR spectrum showed a residual isocyanate content of less than 50% (band at 2270 cm−1).

### Example 8 (Inventive)

As described above a mixture of polyisocyanate A1 (98.0 g), catalyst K1 (1.0 g) and catalyst K3 (6.28 g) was mixed in the Speedmixer at 2750 rpm for 6 min. The reaction mixture was then applied to PE fabric in a vacuum infusion setup. The laminate was kept under vacuum for 5 days at RT. The specimen was subsequently heat-treated for a further 2 hours at 120° C. in a recirculating air oven. The thus obtained material was solid and bubble-free. The IR spectrum showed a residual isocyanate content of less than 20% (band at 2270 cm−1).

### Example 9 (Inventive)

As described above a mixture of polyisocyanate A1 (98.0 g), catalyst K1 (1.0 g) and catalyst K3 (6.28 g) was mixed in the Speedmixer at 2750 rpm for 6 min. The reaction mixture was then applied to PE fabric in a vacuum infusion setup. The laminate was kept under vacuum for 1 day at RT. The thus obtained material was solid and bubble-free. The IR spectrum showed a residual isocyanate content of less than 50% (band at 2270 cm−1).

### Example 10 (Inventive)

As described above a mixture of polyisocyanate A1 (98.0 g), catalyst K1 (1.0 g) and catalyst K3 (6.28 g) was mixed in the Speedmixer at 2750 rpm for 6 min. The reaction mixture was then applied to PE fabric in a vacuum infusion setup. The laminate was kept under vacuum for 1 day at RT. The specimen was subsequently heat-treated for a further 24 hours at 120° C. in a recirculating air oven. The thus obtained material was solid and bubble-free. The IR spectrum no longer showed any residual isocyanate content (band at 2270 cm−1).

Discussion

The working examples show that only the use of polyisocyanates as the reactive component and catalytic conversion thereof to afford crosslinked polyisocyanurates in the presence of one or more trimerization catalysts results in sufficient wetting of fillers based on polyethylene fibers, thus allowing production of composite materials based on polymer fibers (Ex. 1). Comparative example 2 shows that simultaneous use of polyisocyanates and polyols and catalytic conversion thereof to crosslinked polyurethanes results in compatibility problems between filler and matrix. This results in separation of the filler and thus does not result in composite materials. Composite materials based on polyurethanes are not obtainable without preceding compatibilization.

In addition, the working examples clearly show that temperature control is essential during the formation of the composite materials to keep the reaction temperature below the melting point of the filler at all times. While in example 1 both in the pre-crosslinking at 100° C. and in the subsequent postcrosslinking at 140° C. the evolution of heat via the exothermicity of the individual process steps was not sufficient to exceed the melting temperature of the PE fiber, comparative example 3 shows that although the ambient temperature of 140° C. was below the melting point of the PE fiber the evolution of heat via the exothermicity of the individual process step resulted in the melting point of the PE fiber being exceeded since the heat of reaction could not be removed sufficiently quickly.

In addition to the compatibility between the filler and the matrix and the maintenance of the initial properties of the filler it is desirable for industrial applications to achieve the highest possible conversion of reactive groups in the matrix in the shortest possible time. This high conversion was achieved by wetting of PE fabrics in a vacuum infusion setup and subsequent combination of pre-crosslinking at low temperatures (RT) using a catalyst active in this temperature range and a postcrosslinking at high temperatures (120° C.) using another catalyst which in turn shows elevated activity in this temperature range but not at low temperatures (Ex. 10).

1.-16. (canceled)

17. A process for producing a composite material from polymer fibers and crosslinked polyisocyanates, comprising the steps of:
a) providing a polyisocyanate composition A which contains polyisocyanates, and
b) catalytic crosslinking of the polyisocyanate composition A in the presence of at least one polymer fiber B and at least one crosslinking catalyst C to afford the composite material composed of polymer fibers and crosslinked polyisocyanates,
wherein the catalytic crosslinking in process step b) is run in two separate process steps b1) and b2), wherein the temperature is kept at not more than 100° C. in process step b1) and is increased to more than 100° C. but not more than 200° C. in subsequent process step b2).

18. The process as claimed in claim 17, wherein the at least one crosslinking catalyst C is selected from the group consisting of phosphine catalysts of general formula (I) 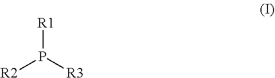
and salts of aliphatic, cycloaliphatic or aromatic mono- and polycarboxylic acids having 2 to 20 carbon atoms.

19. The process as claimed in claim 17, wherein at least two different crosslinking catalysts C1 and C2 are used, wherein the first crosslinking catalyst C1 catalyzes a crosslinking of isocyanate groups to afford at least one of the structures selected from the group consisting of isocyanurate, uretdione, biuret, urea, iminooxadiazinedione, oxadiazinetrione and allophanate groups at reaction temperatures of below 50° C. and the second crosslinking catalyst C2 catalyzes at least one of the abovementioned reactions at reaction temperatures of at least 80° C.

20. The process as claimed in claim 17, wherein the polymer fiber consists of polyethylene.

21. The process as claimed in claim 20, wherein the polymer fiber consists of polyethylene having a molecular weight of at least 360 kg/mol.

22. The process as claimed in claim 20, wherein the polyethylene fiber consists of polyethylene having a polydispersity between 1.1 and 4.0.

23. The process as claimed in claim 17, wherein the tensile strength of the employed polymer fibers is at least 2500 N/mm².

24. The process as claimed in claim 17, wherein before and after the catalytic crosslinking the polyisocyanate composition has a surface energy of not more than 5 mN/m below and not more than 20 mN/m above the surface energy of an untreated polymer fiber B.

25. The process as claimed in claim 17, wherein the polyisocyanate composition A is constructed to an extent of at least 50% by weight from reaction products of 1,4-diisocyanatobutane, 1,5-diisocyanatopentane, 1,6-diisocyanatohexane, isophorone diisocyanate or 4,4′-diisocyanatodicyclohexylmethane or mixtures thereof.

26. The process as claimed in claim 17, wherein the polyisocyanate composition A) has an average NCO functionality of 1.5 to 6.0.

27. The process as claimed in claim 17, wherein the catalytic crosslinking of the isocyanates to afford crosslinked polyisocyanates in process step b) is performed at a temperature of not more than 150° C.

28. A composite material obtained by the process according to claim 17.

29. A composite material, wherein the composite material has a density of not more than 1.2 kg/l determined according to DIN EN ISO 1183-1 and an elastic modulus >3 GPa, contains a polymer fiber B and the polymer matrix thereof has been constructed from a polyisocyanate composition A having an isocyanate index of at least 100.

30. The composite material as claimed in claim 29, wherein the proportion of polyisocyanurate groups in the polymer matrix is at least 30 mol % based on the total number of isocyanurate, uretdione, biuret, urea, iminooxadiazinedione, oxadiazinetrione and allophanate groups.

31. A method comprising providing the composite material according to claim 28 and producing a three-dimensional article.

32. A three-dimensional article comprising the composite material as claimed in claim 28.
